(19) United States
(12) Patent Application Publication
(10) Pub. No.: US 2023/0385615 A1
(43) Pub. Date: Nov. 30, 2023

(54) NORMALIZATION SCHEME FOR SELF-ATTENTION NEURAL NETWORKS

(71) Applicant: HUAWEI TECHNOLOGIES CO., LTD., Shenzhen (CN)

(72) Inventors: Aladin VIRMAUX, Boulogne Billancourt (FR); George Dasoulas, Boulogne Billancourt (FR); Kevin Scaman, Munich (DE)

(21) Appl. No.: 18/365,047

(22) Filed: Aug. 3, 2023

Related U.S. Application Data
(63) Continuation of application No. PCT/EP2021/052679, filed on Feb. 4, 2021.

(51) Int. Cl. G06N 3/048

(52) U.S. Cl. CPC G06N 3/048

(57) ABSTRACT

Described is a data processing device for performing an attention-based operation on a graph neural network. The device is configured to receive one or more input graphs each having a plurality of nodes and to, for at least one of the input graphs: form an input node representation for each node in the respective input graph, wherein a respective norm is defined for each input node representation; form a set of attention parameters; multiply each of the input node representations with each of the set of attention parameters to form a score function of the respective input graph; normalize the score function based on a maximum of the norms of the input node representations to form a normalised score function; and form a weighted node representation by weighting each node in the respective input graph using a respective element of the normalised score function. The normalization of the score function enables deep attention-based neural networks to perform better by enforcing Lipschitz continuity.

### CROSS-REFERENCE TO RELATED APPLICATIONS

This application is a continuation of International Application No. PCT/EP2021/052679, filed on Feb. 4, 2021, the disclosure of which is hereby incorporated by reference in its entirety.

### FIELD

This disclosure relates to graph representations in self-attention neural networks.

### BACKGROUND

The ability to learn accurate representations is seen by many machine learning researchers as the main reason behind the tremendous success of the field in recent years. In areas such as image analysis, natural language processing and reinforcement learning, ground-breaking results rely on efficient and flexible deep learning architectures that are capable of transforming a complex input into a simple vector, whilst retaining most of its valuable features.

Graph representation can tackle a problem of mapping high dimensional objects to simple vectors through local aggregation steps in order to perform machine learning tasks, such as regression or classification. It is desirable to build deep graph neural network architectures based on attention mechanisms, such as deep Graph Attention Networks (GAT) and deep Graph Transformers, for use in such applications.

Many variations have been recently introduced and a main limitation of prior approaches is that many methods do not scale with the number of layers. Deep graph neural network methods in general suffer from oversmoothing and overquashing phenomena in very deep scenarios (see Uri Alon and Eran Yahav, “On the Bottleneck of Graph Neural Networks and its Practical Implications”, eprint={2006.05205}, arXiv, cs.LG, 2021 and Li et al., “Deeper Insights Into Graph Convolutional Networks for Semi-Supervised Learning”, AAAI Conference on Artificial Intelligence, 2018). These phenomena may be explained by intrinsic properties of graph neural networks, such as eigenvalues of the Laplacian, or numerical difficulties such as vanishing or exploding gradient.

There is a rising interest in finding ways to enable deep graph neural networks to perform efficiently in order to capture long range interactions on graphs.

Prior methodologies of building deeper graph neural networks can be divided into two main classes.

Firstly, regularization-level methods, which involve either normalizations of node attributes to stabilize pairwise feature distances, called PairNorm (as described in Lingxiao Zhao and Leman Akoglou, “PairNorm: Tackling Oversmoothing in GNNs”, International Conference on Learning Representations, 2020), or performing dropout of graph edges, called DropEdge (as described in Rong et al., “DropEdge: Towards Deep Graph Convolutional Networks on Node Classification”, International Conference on Learning Representations, 2020) or normalizations of node representations with its variance.

Secondly, intervention in the architecture design level techniques, which comprise co-training and self-training methods of a convolutional network (for example that described in Li et al., “Deeper Insights Into Graph Convolutional Networks for Semi-Supervised Learning”, AAAI Conference on Artificial Intelligence, 2018) or decoupling representation transformation and node propagation, called DAGNN (as described in Liu et al., “Towards Deeper Graph Neural Networks”, Association for Computing Machinery, Proceedings of the 26th ACM SIGKDD International Conference on Knowledge Discovery & Data Mining, pp. 338-348, 2020) or incorporating residual connections, (see Xu et al., “How Powerful are Graph Neural Networks?”, International Conference on Learning Representations, 2019, and Gong et al., “Geometrically Principled Connections in Graph Neural Networks”, eprint={2004.02658}, arXiv, cs.CV, 2020).

Most of the aforementioned methods are based on graph convolutional networks and almost none of these study attention-based graph neural networks. Moreover, no studies have been performed to provide theoretical arguments of effective graph attention normalizations based on Lipschitz continuity.

It is desirable to develop a method that overcomes the above problems.

### SUMMARY

According to a first aspect there is provided a data processing device for performing an attention-based operation on a graph neural network, the device being configured to receive one or more input graphs each having a plurality of nodes and to, for at least one of the input graphs: form an input node representation for each node in the respective input graph, wherein a respective norm can be defined for each input representation; form a set of attention parameters; multiply each of the input node representations with each of the set of attention parameters to form a score function of the respective input graph; normalize the score function based on a maximum of the norms of the input node representations to form a normalised score function; and form a weighted node representation by weighting each node in the respective input graph by means of a respective element of the normalised score function.

The normalization of the score function can enable deep attention-based neural networks to perform better by enforcing Lipschitz continuity. Embodiments of the present invention utilize the maximum norm of inputs for the design of the normalization.

The multiplication of each of the input node representations with each of the set of attention parameters to form a score function of the respective input graph may be performed as a matrix multiplication. The score function may be defined as g(X)=Q^{T}X, where Q denotes the attention parameters and X the input representation of a respective node (which is a set of nodes, more precisely the features of one node and of its neighbors). By decomposing this matrix product, the multiplication is given by Q^{T}Xᵢ where Xᵢ is a node feature, and this is performed for every node. i.e. the multiplication is performed for every node with every attention parameter to give an element of the score function.

In some implementations, the device may be configured to receive multiple input graphs. This may allow the device to be used in applications to detect, for example, the presence of noise in graph data, missing links in networks, and structural patterns.

The score function may be normalized such that the elements of the normalized score function sum to 1. This may allow for efficient normalization of the score function.

The attention mechanism of the graph neural network may be Lipschitz continuous. A function is said to be Lipschitz continuous if there exists L such that ∀x, y|f(x)−f(y)|≤L|x−y|. Thus, f has bounded variations and a bounded gradient. When iterating the function (for example, when calculating f(f(f(. . . f(x) . . . ))) there is a better control on the gradient and it can be assured that it does not explode.

A softmax function may be applied to the normalized score function. The softmax function may be applied to the score function of each node of the graph and the neighbouring nodes of each respective node (those nodes connected to a respective node via edges), such that a set of score function values of each neighborhood sum to 1. As a weighted average is subsequently determined, this may allow the weights of the considered elements of the normalized score function to sum to 1. The softmax function is a convenient way of enabling this.

The input node representation may give contextual information about the respective node. This may allow the method to be used in real-world applications where the input graphs describe physical properties or other parameters. The contextual information may be in the form of a tensor. This may be a convenient representation of the contextual information.

For each node, the respective element of the normalised score function may be combined with the input representation of the respective node using a dot-product to form the weighted node representation of the node based on the weighted representation of its neighboring nodes. This may be an efficient way of forming the weighted node representation.

The graph neural network may be a graph attention network or a graph transformer. The approach is therefore applicable to different attention-based graph neural networks.

The attention mechanism of the graph neural network may comprise a multi-head attention mechanism. The score function may be normalized for every attention head in the multi-head attention mechanism. Thus the method may be conveniently applied to architectures with multi-head attention.

The system may be configured to learn the attention parameters. The learned parameters can then be multiplied with each input node representation to form the score function of the input graph, which is then normalized as described above.

According to a second aspect there is provided a method for performing an attention-based operation on a graph neural network in a data processing device, the device being configured to receive one or more input graphs each having a plurality of nodes, the method comprising, for at least one of the input graphs: forming an input node representation for each node in the respective input graph, wherein a respective norm can be defined for each input node representation; forming a set of attention parameters; multiplying each of the input node representations with each of the set of attention parameters to form a score function of the respective input graph; normalizing the score function based on a maximum of the norms of the input node representations to form a normalised score function; and forming a weighted node representation by weighting each node in the respective input graph by means of a respective element of the normalised score function.

The normalization performed as part of the method can enable deep attention-based neural networks to perform better by enforcing Lipschitz continuity. Embodiments of the present invention utilize the maximum norm of inputs for the design of the normalization.

The score function may be normalized such that the elements of the normalized score function sum to 1. This may allow for efficient normalization of the score function.

The attention mechanism of the graph neural network may be Lipschitz continuous.

According to a third aspect there is provided a computer program which, when executed by a computer, causes the computer to perform the method described above. The computer program may be provided on a non-transitory computer readable storage medium.

### BRIEF DESCRIPTION OF THE FIGURES

The present embodiments will now be described by way of example with reference to the accompanying drawings. In the drawings:

FIG. 1 shows the general pipeline for embodiments of the present invention.

FIG. 2 schematically illustrates the score function g(x) of attention modules for two heads.

FIG. 3 illustrates an example of the train/validation accuracy throughout training on the Cora dataset (see A. McCallum et al., “Automating the Construction of Internet Portals with Machine Learning”, Information Retrieval, Vol. 3, No. 2, pp. 127-163, 1 Jul. 2000) using a GAT model.

FIG. 4 illustrates an example of the train/validation accuracy throughout training on the Cora dataset using a Graph Transformer model.

FIG. 5 illustrates the impact of normalization to the increasing depth of a GAT model on the Cora dataset.

FIG. 6 illustrates a method for performing an attention-based operation on a graph neural network in a data processing system.

FIG. 7 schematically illustrates an example of an apparatus for implementing the method described herein and some of its associated components.

### DETAILED DESCRIPTION

The method described herein concerns building deep graph neural network architectures based on attention mechanisms, such as deep Graph Attention Networks (GAT) and deep Graph Transformers. Such neural networks are referred to as attention-based graph neural networks.

Embodiments of the present invention tackle one or more of the problems previously mentioned by introducing a normalization of the score function of the attention mechanism. In this way, it is possible to control the Lipschitz constant of the attention head that theoretically allows for the building of a very deep neural network without loss of efficiency.

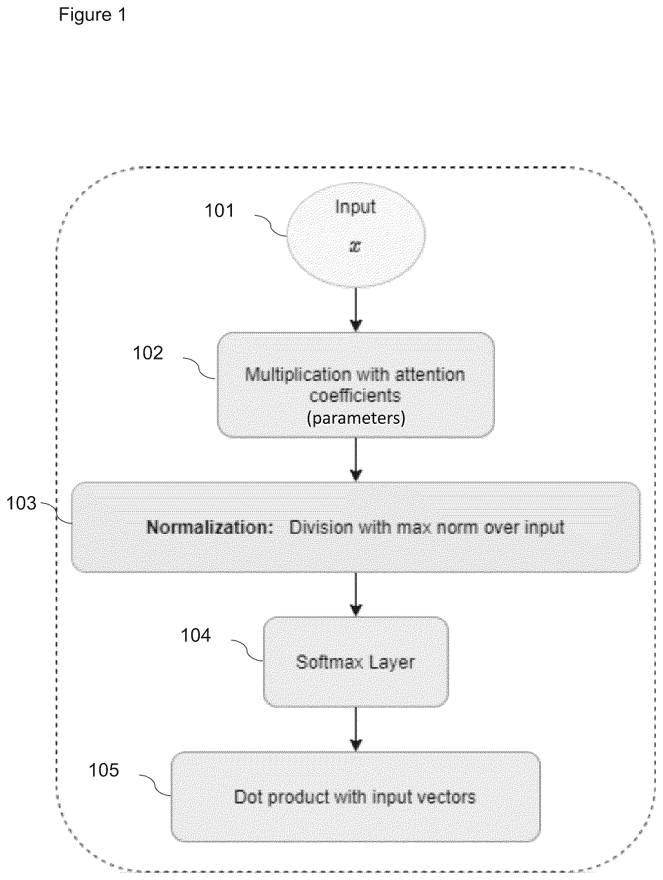

In the method described herein, the score function values are normalized based on the maximum of the norms of the inputs. In FIG. 1, a diagram of the steps performed in the attention module as part of the method are shown.

As shown in FIG. 1, in an implementation, the steps of the attention modules in the graph setting comprise:
a) Inputting a node representation x for each node in the graph, as shown at 101. This representation gives contextual information of each node, which is preferably in the form of a tensor. The norms of the input node representations are additionally computed. These are used later in the normalization.
b) Multiplication of input with attention parameters, as shown at 102. The parameters can give different importance to different neighbors (i.e. those nodes connected to a node of interest via edges) of nodes in the graph. The output of this multiplication is referred to as the score function of the input.
c) Normalization of the score function, as shown at 103. In a preferred implementation, the score function is divided with the product of the maximum norm of the inputs and a function of the norm of the attention parameters (the attention parameters being denoted by Q in the following description)
d) Softmax function application, as shown at 104. In order to transform the multiplication output into a normalized variable that sums to 1, a softmax function is applied. In the graph setting, this function is applied neighbor-wise, so that the set of score function values of each neighborhood (i.e. the node of interest, i, and the nodes connected to that node via edges) sums to 1.
e) Weighted average from previous output with input representation, as shown at 105. Taking the normalized score function values, the result is combined with the input representation using a dot-product to take the final representations of each node based on the weighted information of its neighbors.

The system may be configured to learn the set of attention parameters. Initial values of the attention parameters may be randomly defined. Each of the learned set of attention parameters can then be multiplied with each input node representation to form the score function of the input graph, which is then normalized as described above.

The attention coefficients for each graph are computed based on the nodes of the graph (and their features) and the attention parameters.

The normalization performed as part of the method (at step 103 in FIG. 1) can enable deep attention-based neural networks to perform better by enforcing Lipschitz continuity. Embodiments of the present invention utilize the maximum norm of inputs for the design of the normalization.

A function is said to be Lipschitz continuous if there exists L such that ∀x, y|f(x)−f(y)|≤L|x−y|. Thus, f has bounded variations and a bounded gradient. When iterating the function (for example, when calculating f(f(f( . . . f(x) . . . ))) there is a better control on the gradient and it can be assured that it does not explode.

The normalization of the score function of the input using the maximum norm of inputs of the attention mechanism stabilizes the Lipschitz bounds of the attention blocks. Moreover, it enhances the performance of deep graph attention networks (see Veličlović et al., “Graph Attention Networks”, International Conference on Learning Representations, 2018) and deep graph transformers (see Shi et al., “Masked Label Prediction: Unified Message Passing Model for Semi-Supervised Classification”, 2020, eprint={2009.03509}, arXiv, cs.LG, 2020) on standard node classification benchmarks.

An example of the method will now be described in more detail.

In the following description, the following notations are consistently used: [symbol] is the field of real numbers, for every matrix A=(a_{i,j})∈ [symbol] , ∥A∥_{F} denotes its Frobenius norm.

∥A∥_{F}=\sqrt{Σa_{i,j}²} and the L_{p,q} a norm is defined as the inner application of column-wise L_{q} norm to matrix A followed by the application of Lₚ norm:

$$‖ A {‖}_{( p , q )} = {( {\sum }_{j = 1}^{n} {( {\sum }_{j = 1}^{n} \vert {a}_{i , j} {\vert}^{p} )}^{\frac{q}{p}} )}^{\frac{1}{q}}$$

The formulation of the attention mechanism for graph attention transformers (GAT) will now be described.

Following Veličković et al., 2018 (referenced above), the attention module on a graph is defined in the following way.

Let G=(V, E) be a graph and every node νᵢ carries a feature h={h₁, . . . , h_{N}}, xᵢ∈ [symbol] . The attention mechanism takes the former as input and outputs a new set of node features h′={h′₁, . . . , h′_{N}}, h′ᵢ∈ [symbol] .

For every node, the method first computes weights depending on the neighboring of the node and then computes a weighted average between the feature of the node and its neighbors based on the previously computed weights.

In one example, for a feature node hᵢ, all the incoming edges are considered and assigned to each of them is the vector that represents the concatenation of both node features xⱼ=hᵢΠhⱼ.

The general formula is given by:

$$f {(}_{i} ( h ) = {\sum }_{j = 1}^{N} w ( {x}_{j} ) {h}_{i} with$$

$$w ( {x}_{i} ) = \frac{{e}^{g ( {x}_{i} )}}{{e}^{g ( {x}_{j} )}}$$

Note that [symbol] w(xⱼ)=1.

In the graph setting, the summands j∈{1, . . . , N} run over the neighborhood of node i.

The graph attention network comprises several layers of this mechanism.

For multi-head attention, the above formulation can be extended in the case where the score function g(x) is computed multiple times in order to capture different information.

These multiple computations are referred to as heads and the incorporation of multiple heads can be expressed as a concatenation of the different outputs given by different score function gₖ(x): \check{g}(x)=[g₁(x), . . . gₖ(x)].

$$f ( x ) = \prod {f}_{k} ( x )$$

with Π being concatenation, and each attention head fₖ calls the score function gₖ.

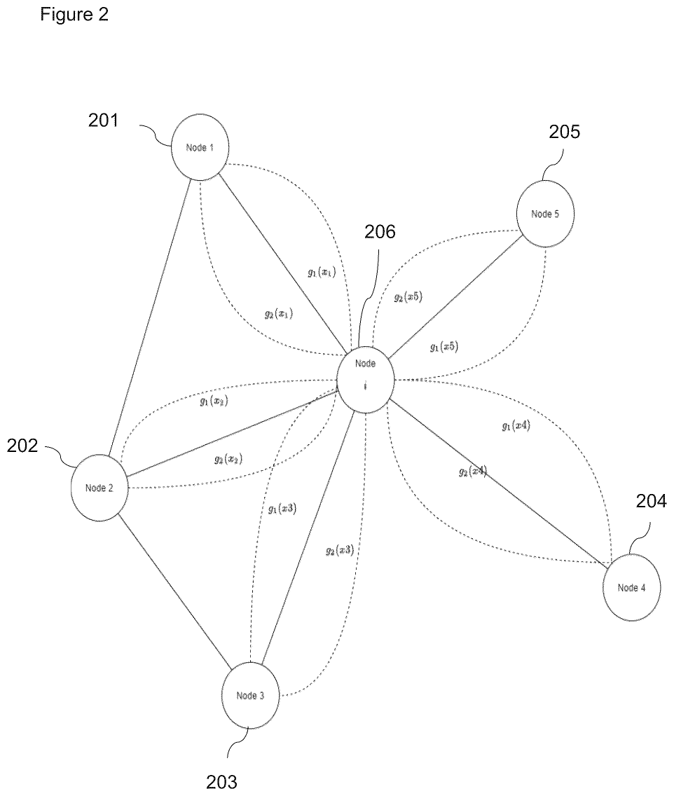

A visualization of the multi-head score functions is shown in FIG. 2. The neighbor nodes 201, 202, 203, 204 and 205 and node i 206 are shown.

For the linear case used in GATs, in the former (see Veličlović et al., 2018, referenced above), for every xᵢ∈V the features of the neighborhood of xᵢ are stacked into X∈ [symbol] . In this example, given a matrix of learnable attention parameters Q∈ [symbol] , the score function is given by:

g(X)=Q^{T}X

The multiplication of each of the input node representations with each of the set of attention parameters to form a score function of the respective input graph may be performed as a matrix multiplication. The score function may be defined as g(X)=Q^{T}X, where Q denotes the attention parameters and X the input (a set of nodes, more precisely the feature of one node i and of its neighbors). By decomposing this matrix product, the multiplication is given by Q^{T}Xᵢ where X i is a node feature, and this is performed for every node. i.e. the multiplication is performed for every node with every attention parameter to give an element of the score function.

A normalization scheme is added to this score function in order to assure that the attention mechanism is Lipschitz continuous. Hence, in this example, the following score function may be used in order to perform the attention:

$$g ( X ) = \frac{{Q}^{T} X}{{‖ Q ‖}_{F} ‖ {X}^{T} {‖}_{( ∞ , 2 )}}$$

with Q being the learnable attention parameter.

The formation of the whole GAT network is similar to as previously explained, using this normalization scheme for every attention head.

For the quadratic case that is used in Transformer models in NLP (see Vaswani et al., “Attention is all you need”, Advances in Neural Information Processing Systems 30, NIPS, pp. 5998-6008, 2017) and in graphs (see Shi et al., 2020, referenced above), the attention mechanism works as follows.

There are three matrices of parameters W_{Q}, W_{K}, W_{V}∈ [symbol] that act linearly on the input sequence x₁, . . . , x_{N}∈ [symbol] to obtain Q=W_{Q}X, K=W_{K}K and V=W_{V}V.

The score function is g(Q, K)=Q^{T}K and the global attention is defined by:

Att(Q, K, V)=Softmax_{row}(g(Q, K))V

In this example, the following normalization is introduced:

$$g ( Q , K , V ) = \frac{{Q}^{T} X}{c ( Q , K , V )}$$

where c(Q, K, V)=max{uv, uw, vw} with u=∥Q∥_{F}, v=∥K^{T}∥_{(∞,2)} and w=∥V^{T}∥_{(∞,2)}.

The multi-head setting is handled similarly to the linear case. The attention mechanism is computed for several triples or independent parameters. Its concatenation is output.

Therefore, the normalization method for attention-based neural network architectures comprises the main components as follows: 1) the computation of inner products between input values and query vectors, 2) the computation of the norm of all inputs, 3) the ratio of inner products with the maximum of input norms.

The introduced normalization has been examined in node classification scenarios, where given a graph and a part of labeled nodes, the goal is to predict the label of the unlabeled nodes. Assuming a large graph, long-range interactions (interactions between nodes that lie in distant places of the same network) play an important role and deep graph neural network architectures have been used.

The contribution of the described normalization of the score function has been compared with other normalization techniques in attention-based architectures including GAT (see Veličlović et al., 2018, referenced above) and Graph Transformers (see Shi et al., 2020, referenced above).

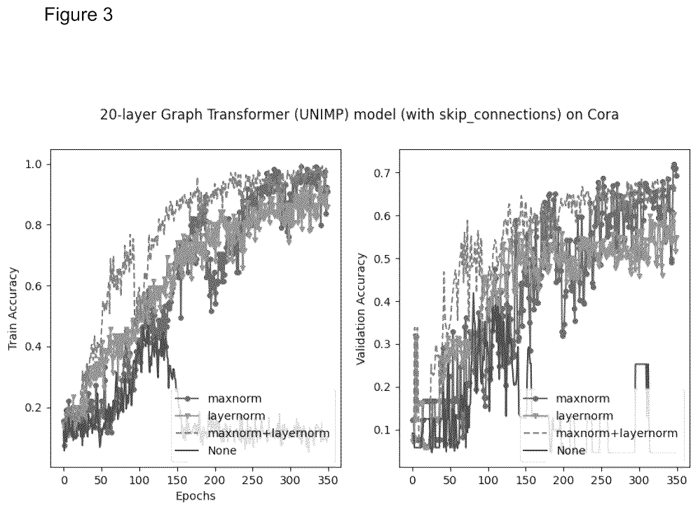

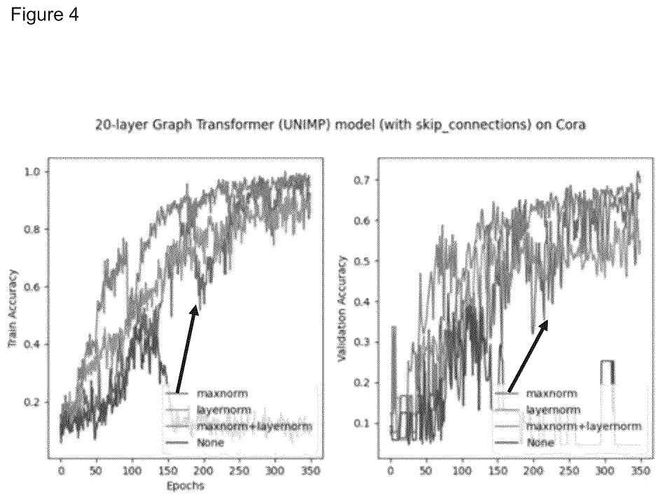

In the exemplary results shown in FIGS. 3 to 5, there are 20 layers and the hidden dimensionality=128. FIG. 3 illustrates an example of the train/validation accuracy throughout training on the Cora dataset (A. McCallum et al., “Automating the Construction of Internet Portals with Machine Learning”, Information Retrieval, Vol. 3, No. 2, pp. 127-163, 1 Jul. 2000) using a GAT model. FIG. 4 illustrates an example of the train/validation accuracy throughout training on the Cora dataset using a Graph Transformer model.

FIGS. 3 and 4 show the contribution of the normalization described herein (shown as ‘maxnorm’) in a deep architecture throughout training. The convergence is faster and the accuracy higher when using the method described herein compared to the other methods. Use of the ‘maxnorm’ method has a quick impact on the model performance and in this exemplary implementation outperforms the standard model and other normalizations shown.

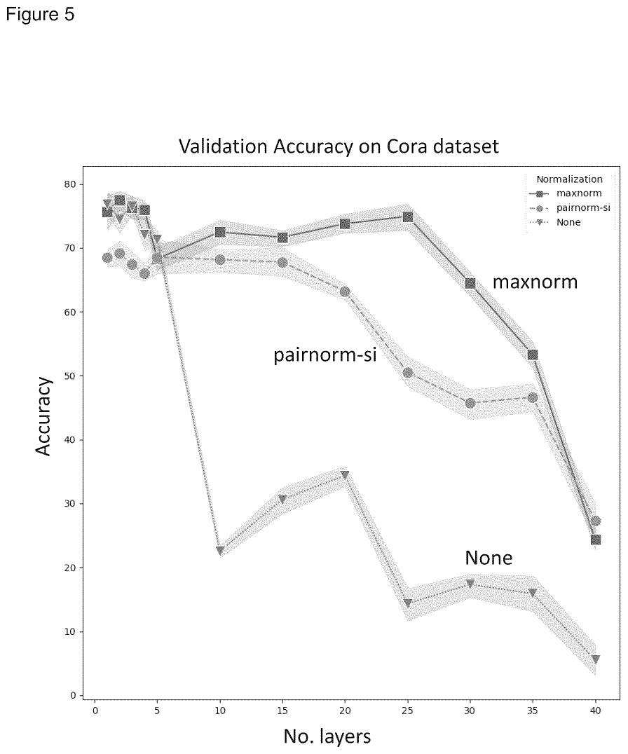

Moreover, as the depth of the architecture increases, the described normalization maintains a higher efficiency of the model. This is illustrated in FIG. 5, which shows the impact of normalization with increasing depth of a GAT model on the Cora dataset.

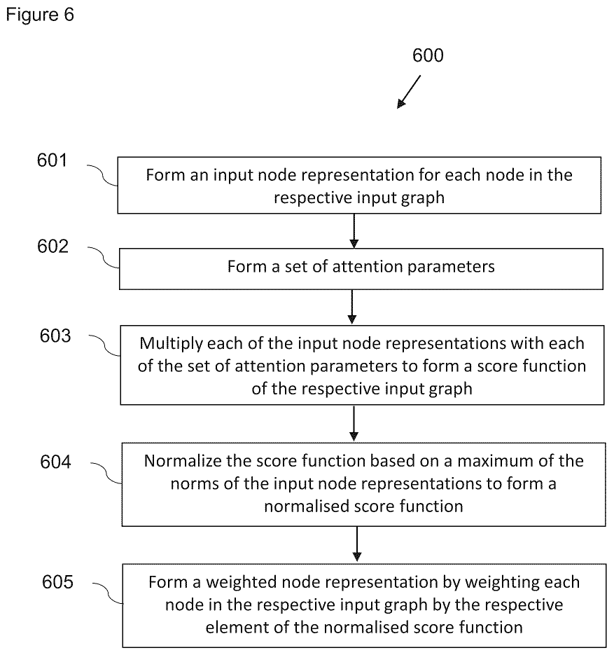

FIG. 6 summarises an example of a method for implementing a machine learning process in dependence on a graph neural network in a data processing device, the device being configured to receive one or more input graphs each having a plurality of nodes, at least some of the nodes having an attribute. For at least one of the input graphs, the method comprises, at step 601, forming an input node representation for each node in the respective input graph, wherein a respective norm can be defined for each input node representation. At step 602, the method comprises forming a set of attention parameters. In the preferred implementation, the attention parameters are learned. At step 603, the method comprises multiplying each of the input node representations with each of the set of attention parameters to form a score function of the input graph. This may be performed by matrix multiplication. At step 604, the method comprises normalizing the score function based on a maximum of the norms of the input node representations to form a normalised score function. At step 605, the method comprises forming a weighted node representation by weighting each node in the respective input graph by means of a respective element of the normalised score function.

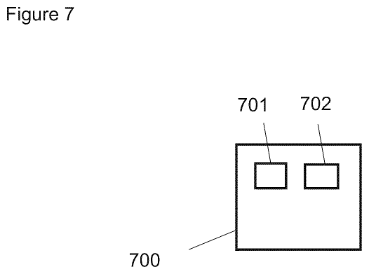

FIG. 7 shows a schematic diagram of a data processing device 700 configured to implement the networks described above and its associated components. The device may comprise a processor 701 and a non-volatile memory 702. The device may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein. The components may be implemented in physical hardware or may be deployed on various edge or cloud devices.

The method may be practically applied in areas such as image analysis, natural language processing and reinforcement learning. Forming graph representations may allow for the mapping high dimensional objects to simple vectors through local aggregation steps in order to perform machine learning tasks such as regression or classification.

The method may for example, be used to detect the presence of noise in graph data, missing links in networks, structural patterns (for example, symmetries), and to show that distant atoms can play a role in molecular formations.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A data processing device for performing an attention-based operation on a graph neural network, the device being configured to receive one or more input graphs each having a plurality of nodes and to, for at least one of the input graphs:
form an input node representation for each node in the respective input graph, wherein a respective norm is defined for each input node representation;
form a set of attention parameters;
multiply each of the input node representations with each of the set of attention parameters to form a score function of the respective input graph;
normalize the score function based on a maximum of the norms of the input node representations to form a normalised score function; and
form a weighted node representation by weighting each node in the respective input graph using a respective element of the normalised score function.

2. The data processing device of claim 1, wherein the score function is normalized such that the elements of the normalized score function sum to 1.

3. The data processing device of claim 1, wherein an attention mechanism of the graph neural network is Lipschitz continuous.

4. The data processing device of claim 1, wherein a softmax function is applied to the normalized score function.

5. The data processing device of claim 1, wherein a softmax function is applied to the score function of each node of the graph and the neighbouring nodes of each respective node, such that a set of score function values of each neighborhood sum to 1.

6. The data processing device of claim 1, wherein the input node representation gives contextual information about the respective node.

7. The data processing device of claim 6, wherein the contextual information is in the form of a tensor.

8. The data processing device of claim 1, wherein for each node, the respective element of the normalised score function is combined with the input representation of the respective node using a dot-product to form the weighted node representation of the node based on the weighted representation of its neighboring nodes.

9. The data processing device of claim 1, wherein the graph neural network is a graph attention network or a graph transformer.

10. The data processing device of claim 1, wherein an attention mechanism of the graph neural network comprises a multi-head attention mechanism.

11. The data processing device of claim 10, wherein the score function is normalized for every attention head in the multi-head attention mechanism.

12. The data processing device of claim 1, wherein the system is configured to learn the attention parameters.

13. A method for performing an attention-based operation on a graph neural network in a data processing device, the device being configured to receive one or more input graphs each having a plurality of nodes, the method comprising, for at least one of the input graphs:
forming an input node representation for each node in the respective input graph, wherein a respective norm is defined for each input node representation;
forming a set of attention parameters;
multiplying each of the input node representations with each of the set of attention parameters to form a score function of the respective input graph;
normalizing the score function based on a maximum of the norms of the input node representations to form a normalised score function; and
forming a weighted node representation by weighting each node in the respective input graph using a respective element of the normalised score function.

14. The method of claim 13, wherein the score function is normalized such that the elements of the normalized score function sum to 1.

15. The method of claim 13, wherein an attention mechanism of the graph neural network is Lipschitz continuous.

16. A non-transitory computer readable medium storing a computer program which, when executed by a computer, causes the computer to perform the method of any of claim 13.
